(19) United States
(12) Patent Application Publication
(10) Pub. No.: US 2024/0332600 A1
(43) Pub. Date: Oct. 3, 2024

(54) STACK MANUFACTURING METHOD

(71) Applicant: Prime Planet Energy & Solutions, Inc., Tokyo (JP)

(72) Inventor: Daichi KOBORI, Kobe-shi (JP)

(21) Appl. No.: 18/616,182

(22) Filed: Mar. 26, 2024

(30) Foreign Application Priority Data
Mar. 30, 2023 (JP) 2023-055073

(51) Int. Cl. H01M 10/04; H01M 10/44

(52) U.S. Cl. CPC H01M 10/0481; H01M 10/446

(57) ABSTRACT

The present disclosure provides a stack manufacturing method including a preparing step involving preparing storage cells. When the storage cells prepared in the preparing step undergo five cycles of a process involving applying a load of up to 0.1 MPa to each of the storage cells at a speed of 0.1 mm/min in the thickness direction of each of the storage cells and then reducing the load to 0.01 MPa at a speed of 0.1 mm/min, a relationship between a storage cell thickness X1 determined relative to a contact pressure of 0.04 MPa by a pressurized side F-s curve in a first cycle and a storage cell thickness X5 determined relative to a contact pressure of 0.04 MPa by a pressurized side F-s curve in a fifth cycle satisfies the following expression: (X1−X5)/X1×100≥0.3.

### CROSS REFERENCE TO RELATED APPLICATIONS

This application claims the benefit of priority to Japanese Patent Application No. 2023-055073 filed on Mar. 30, 2023. The entire contents of this application are hereby incorporated herein by reference.

### BACKGROUND

### 1. Field of the Invention

The present disclosure relates to stack manufacturing methods.

### 2. Description of the Related Art

Stacks each including storage cells have recently been used as suitable driving power sources to be installed on vehicles, such as hybrid electric vehicles (HEVs), plug-in hybrid electric vehicles (PHEVs), and battery electric vehicles (BEVs). Prior art documents related to such stacks include JP 2018-055806 A. JP 2018-055806 A discloses a technique concerning a nonaqueous electrolytic solution secondary battery (which is a storage cell) including a casing, a nonaqueous electrolytic solution (or a nonaqueous electrolyte), and an electrode assembly. The electrode assembly includes: a positive electrode; a negative electrode having a first spring constant; and a separator. The electrode assembly further includes a low spring constant film having a second spring constant lower than the first spring constant. Providing the low spring constant film reduces extrusion of the nonaqueous electrolytic solution from inside the electrode assembly, which is caused by expansion and contraction of the electrode assembly. Stacks known in the related art are used, with storage cells stacked and restrained by a load applied thereto.

### SUMMARY

When a stack is used in a low temperature or low state-of-charge (SOC) condition, nonaqueous electrolytes are extruded out of electrode assemblies inside storage cells, resulting in decreases in thicknesses of the storage cells. In such a state, return of the nonaqueous electrolytes to the electrode assemblies increases the thicknesses of the storage cells again so as to maintain a stack restraining load. If the nonaqueous electrolytes have difficulty in returning to the electrode assemblies inside the storage cells, however, the storage cells still have small thicknesses and the stack restraining load is thus still at a low level, making it impossible to sufficiently restrain the storage cells. As used herein, the term “stack restraining load” refers to a load applied to restrain storage cells of a stack. In view of the above problem, stack manufacturing requires giving consideration not only to extrusion of nonaqueous electrolytes from inside electrode assemblies of storage cells but also to returnability of the nonaqueous electrolytes to the electrode assemblies. In this regard, the technique disclosed in JP 2018-055806 A gives no consideration to returnability of nonaqueous electrolytes into electrode assemblies and thus has room for improvement.

Accordingly, embodiments of the present disclosure provide stack manufacturing methods that are able to suitably control thicknesses of storage cells stacked into stacks and to prevent decreases in stack restraining loads.

An embodiment of the present disclosure provides a method for manufacturing a stack including rectangular storage cells. The method includes a preparing step and a stacking step. The preparing step involves preparing the storage cells each including: a flat wound electrode assembly provided by placing a positive electrode and a negative electrode in layers, with a separator interposed therebetween, and winding the positive electrode, the negative electrode, and the separator; a nonaqueous electrolyte; and a case containing the wound electrode assembly and the nonaqueous electrolyte. The stacking step involves stacking the storage cells in a thickness direction of the storage cells. When the storage cells prepared in the preparing step undergo five cycles of a process involving applying a load of up to 0.1 MPa to each of the storage cells at a speed of 0.1 mm/min in the thickness direction of each of the storage cells and then reducing the load to 0.01 MPa at a speed of 0.1 mm/min, a relationship between a storage cell thickness X1 determined relative to a contact pressure of 0.04 MPa by a pressurized side F-s curve in a first cycle and a storage cell thickness X5 determined relative to a contact pressure of 0.04 MPa by a pressurized side F-s curve in a fifth cycle satisfies the following expression: (X1−X5)/X1×100≥0.3.

The storage cells prepared in the preparing step satisfy the above expression. The storage cells satisfying the above expression each have a thickness difference for allowing the nonaqueous electrolyte, which has been extruded out of each wound electrode assembly in the stacking step, to return again into each wound electrode assembly. Accordingly, the wound electrode assemblies of the storage cells capture the nonaqueous electrolytes again and thus have increased thicknesses, resulting in an increase in thickness of each storage cell. Consequently, the embodiment of the present disclosure is able to reduce a decrease in the load applied to the storage cells, with the result that the load applied to the storage cells of the stack is maintained at a sufficient level.

### BRIEF DESCRIPTION OF THE DRAWINGS

FIG. 1 is a schematic perspective view of a stack according to an embodiment of the present disclosure.

FIG. 2 is a perspective view of a storage cell.

FIG. 3 is a schematic vertical cross-sectional view of the storage cell taken along the line III-III in FIG. 2.

FIG. 4 is a schematic perspective view of wound electrode assemblies attached to a sealing plate.

FIG. 5 is a schematic perspective view of the wound electrode assembly.

FIG. 6 is a schematic view of a structure of the wound electrode assembly.

FIG. 7 is a flow chart of a stack manufacturing method according to the present embodiment.

FIG. 8 is a graph illustrating exemplary F-s curves obtained in a preparing step according to the present embodiment.

FIG. 9A is a schematic diagram illustrating a thickness of the wound electrode assembly before the storage cells of the stack are restrained.

FIG. 9B is a schematic diagram illustrating a thickness of the wound electrode assembly while the storage cells of the stack are restrained.

FIG. 9C is a schematic diagram illustrating a thickness of the wound electrode assembly when a nonaqueous electrolyte has returned to the wound electrode assembly.

FIG. 10 is a schematic diagram illustrating a cell thickness change rate measuring process in the preparing step.

FIG. 11 is a flow chart of a storage cell manufacturing method according to the present embodiment.

FIG. 12 is a graph that plots cell thickness changes between a first cycle and a fifth cycle under the same load conditions for each of Examples 1 and 2 and Comparative Example 2, where the horizontal axis represents A cell thicknesses (mm) and the vertical axis represents applied loads (kN).

FIG. 13A is a schematic diagram illustrating a thickness of a wound electrode assembly according to a conventional example before storage cells of a stack are restrained.

FIG. 13B is a schematic diagram illustrating a thickness of the wound electrode assembly according to the conventional example while the storage cells of the stack are restrained.

FIG. 13C is a schematic diagram illustrating a thickness of the wound electrode assembly according to the conventional example when a nonaqueous electrolyte has returned to the wound electrode assembly.

FIG. 14 is a graph illustrating exemplary F-s curves according to the conventional example.

### DETAILED DESCRIPTION

Preferred embodiments of stacks disclosed herein will be described below with reference to the drawings. Matters that are not specifically mentioned herein but are necessary for carrying out the present disclosure (e.g., common storage cell structures and manufacturing processes that do not characterize the present disclosure) may be understood by those skilled in the art as design matters based on techniques known in the related art. The stacks disclosed herein may be manufactured on the basis of the description given herein and common technical knowledge in the related art.

Components or elements having the same functions are identified by the same reference signs in the drawings below and may be described briefly or may not be described when deemed redundant. Any range between “A” and “B” used herein (where A is a numerical value representing the lower limit of the range and B is a numerical value representing the upper limit of the range) may be inclusive of A and B, or may preferably be greater than A and less than B.

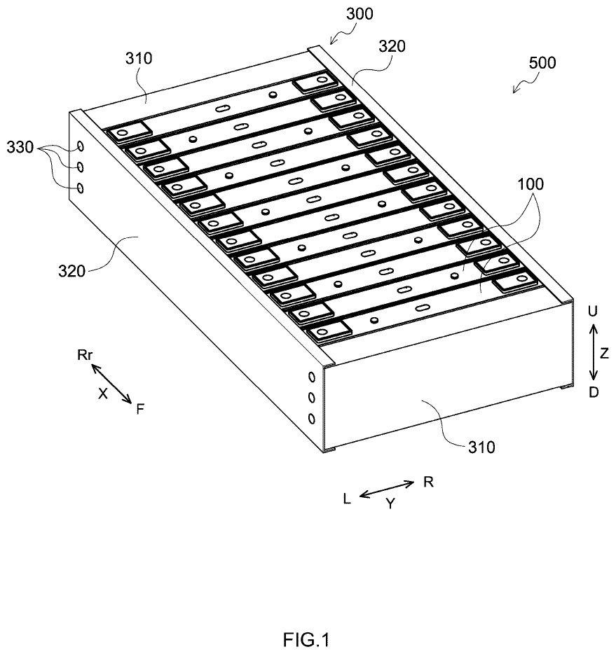

FIG. 1 is a schematic perspective view of a stack 500 according to an embodiment of the present disclosure. In the present embodiment, the stack 500 includes storage cells 100 and a restrainer 300. Although not illustrated for the sake of convenience of description, the storage cells 100 of the stack 500 are electrically connected to one another through bus bars. In the following description, the reference signs L, R, F, Rr, U, and D in the drawings respectively represent left, right, front, rear, up, and down. The reference sign X in the drawings represents a short side direction of the storage cells 100. The reference sign Y in the drawings represents a long side direction of the storage cells 100 perpendicular to the short side direction X. The reference sign Z in the drawings represents an up-down direction of the storage cells 100 perpendicular to the short side direction X and the long side direction Y. The storage cells 100 are disposed side by side in the short side direction X. The short side direction X may also be hereinafter referred to as a “thickness direction X”. The long side direction Y may also be hereinafter referred to as a “width direction Y”. These directions, however, are defined merely for the sake of convenience of description and do not limit in any way how the stack 500 may be installed.

The restrainer 300 is configured to apply a predetermined restraining pressure to the storage cells 100 in the thickness direction X. In the present embodiment, the restrainer 300 includes a pair of end plates 310, a pair of side plates 320, and screws 330. The pair of end plates 310 are disposed at a distance from each other in the predetermined thickness direction X. One of the pair of end plates 310 is disposed at a first end of the stack 500 in the thickness direction X, and the other one of the pair of end plates 310 is disposed at a second end of the stack 500 in the thickness direction X. The storage cells 100 are disposed between the pair of end plates 310 in the thickness direction X. Insulting sheets or inter-cell separators, for example, may be disposed between the storage cells 100.

The pair of side plates 320 each serve as a bridge between the pair of end plates 310. In one example, the pair of side plates 320 are secured to the end plates 310 with the screws 330 while a load is applied to the storage cells 100. The restrainer 300 thus applies a restraining load to the storage cells 100 in the thickness direction X such that the storage cells 100 are held together so as to form the stack 500. The restrainer 300, however, is not limited to this arrangement. In one example, the restrainer 300 may include restraining band(s) or binding bar(s) instead of the side plates 320.

### Storage Cell 100

As used herein, the term “storage cell” refers to any device that is repeatedly chargeable and dischargeable. The term “storage cell” subsumes not only batteries generally known as lithium ion batteries and lithium secondary batteries but also lithium polymer batteries and lithium ion capacitors. As used herein, the term “secondary battery” refers to any battery in general that is repeatedly chargeable and dischargeable by movement of charge carriers between positive and negative electrodes. The following description is based on the assumption that a lithium ion second battery is a form of a storage cell.

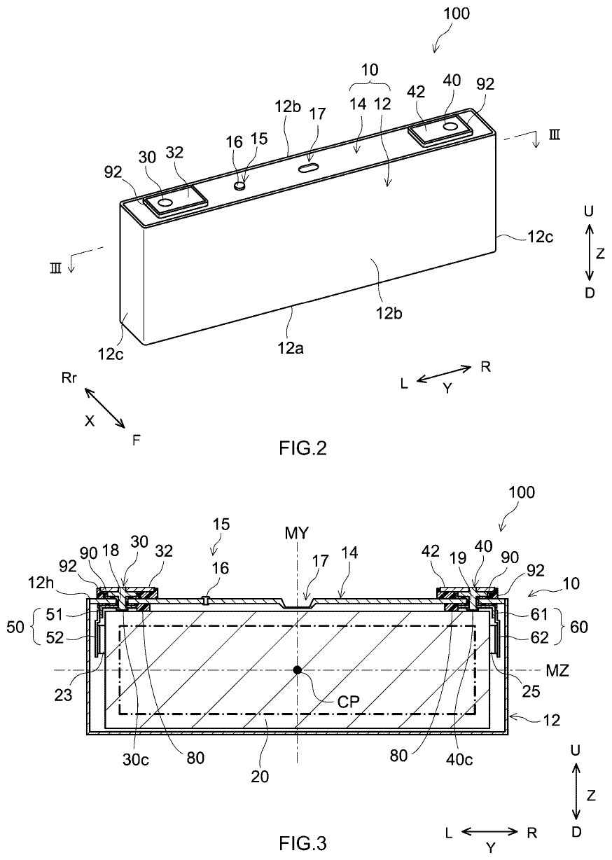

FIG. 2 is a perspective view of one of the storage cells 100. As illustrated in FIGS. 1 and 2, the storage cells 100 are disposed side by side in the thickness direction X such that pairs of first side walls 12b (which will be described below) face each other. FIG. 3 is a schematic vertical cross-sectional view of the storage cell 100 taken along the line III-III in FIG. 2. As illustrated in FIG. 3, each storage cell 100 includes a case 10, a wound electrode assembly 20, a nonaqueous electrolyte (not illustrated), a positive electrode terminal 30, a negative electrode terminal 40, a positive electrode collector 50, and a negative electrode collector 60. In the present embodiment, the storage cells 100 are lithium ion secondary batteries.

The case 10 is a casing for containing the wound electrode assembly 20 and the nonaqueous electrolyte. As illustrated in FIG. 2, the case 10 has a flat cuboidal outer shape (or a flat rectangular outer shape) with a bottom. The case 10 may be made of any material known in the related art or any other suitable material. The case 10 is preferably made of metal. The case 10 is more preferably made of a metallic material, such as aluminum, an aluminum alloy, iron, or an iron alloy. As illustrated in FIG. 2, the case 10 includes: an outer body 12 provided with an opening 12h (see FIG. 3); and a sealing plate (or a lid) 14 sealing the opening 12h. Although the case 10 may include any other suitable components, the case 10 preferably includes, as in the present embodiment, the outer body 12 provided with the opening 12h and the sealing plate 14 sealing the opening 12h.

As illustrated in FIG. 2, the outer body 12 includes: a bottom 12a; the pair of first side walls 12b extending from the bottom 12a and facing each other; and a pair of second side walls 12c extending from the bottom 12a and facing each other. The bottom 12a has a substantially rectangular shape. The bottom 12a faces the opening 12h (see FIG. 3). The first side walls 12b are flat. The first side walls 12b extend from long sides of the bottom 12a. The second side walls 12c extend from short sides of the bottom 12a. The first side walls 12b are larger in area than the second side walls 12c. Although the outer body 12 may have any suitable size, the outer body 12 preferably has, for example, a length of between 300 mm and 330 mm in the long side direction Y, a height of between 100 mm and 130 mm in the up-down direction Z, and a thickness of between 30 mm and 50 mm in the short side direction X.

The sealing plate 14 is attached to the outer body 12 such that the sealing plate 14 closes the opening 12h of the outer body 12. The sealing plate 14 faces the bottom 12a of the outer body 12. The sealing plate 14 has a substantially rectangular shape in a plan view. The sealing plate 14 is connected (or preferably welded) to a portion of the outer body 12 defining a peripheral edge of the opening 12h such that the outer body 12 and the sealing plate 14 are integral with each other so as to constitute the case 10. The case 10 is airtightly sealed.

As illustrated in FIG. 3, the sealing plate 14 is provided with a pouring hole 15, a discharge valve 17, a terminal drawing hole 18, and a terminal drawing hole 19. After the sealing plate 14 is assembled to the outer body 12, the nonaqueous electrolyte is poured into the case 10 through the pouring hole 15. The pouring hole 15 is sealed with a sealing member 16. The discharge valve 17 is configured to discharge gas from inside to outside the case 10 by being ruptured when a pressure inside the case 10 is at or higher than a predetermined level. The terminal drawing holes 18 and 19 pass through the sealing plate 14 in the up-down direction Z. The terminal drawing hole 18 has an inner diameter that allows insertion of the positive electrode terminal 30 through the terminal drawing hole 18 before the positive electrode terminal 30 is assembled (or swaged) to the sealing plate 14. The terminal drawing hole 19 has an inner diameter that allows insertion of the negative electrode terminal 40 through the terminal drawing hole 19 before the negative electrode terminal 40 is assembled (or swaged) to the sealing plate 14.

The nonaqueous electrolyte may be any nonaqueous electrolyte known in the related art or any other suitable nonaqueous electrolyte. The nonaqueous electrolyte contains a nonaqueous solvent and a supporting electrolyte (or an electrolytic salt). The nonaqueous electrolyte may further contain an additive when necessary. The nonaqueous solvent preferably contains carbonates, examples of which include ethylene carbonate, dimethyl carbonate, and ethyl methyl carbonate. The nonaqueous solvent particularly preferably contains cyclic carbonate and chain carbonate. Examples of the supporting electrolyte include a fluorine-containing lithium salt, such as lithium hexafluorophosphate (LiPF₆). Examples of the additive that may be contained in the nonaqueous electrolyte include a film forming agent, a gas generating agent, a dispersant, and a thickener. Examples of the film forming agent include: carbonate compounds, such as vinylene carbonate (VC), vinylethylene carbonate (VEC), fluoroethylene carbonate (FEC), chloroethylene carbonate (CEC), and methylphenyl carbonate (MPC); and lithium salts whose anions are oxalato complexes, such as lithium bis(oxalato)borate (LiBOB), lithium difluoro(oxalato)borate (LiDFOB), and lithium difluorobis(oxalato)phosphate (LiDFBOP).

The positive electrode terminal 30 is disposed on a first end of the sealing plate 14 in the long side direction Y (i.e., a left end of the sealing plate 14 in FIGS. 2 and 3). The negative electrode terminal 40 is disposed on a second end of the sealing plate 14 in the long side direction Y (i.e., a right end of the sealing plate 14 in FIGS. 2 and 3). As illustrated in FIG. 3, the positive electrode terminal 30 extends from inside to outside the sealing plate 14 through the terminal drawing hole 18, and the negative electrode terminal 40 extends from inside to outside the sealing plate 14 through the terminal drawing hole 19. The positive electrode terminal 30 and the negative electrode terminal 40 are secured to the sealing plate 14. In the present embodiment, the positive electrode terminal 30 is swaged to a portion of the sealing plate 14 defining a peripheral edge of the terminal drawing hole 18, and the negative electrode terminal 40 is swaged to a portion of the sealing plate 14 defining a peripheral edge of the terminal drawing hole 19. An end of the positive electrode terminal 30 located inside the outer body 12 (i.e., a lower end of the positive electrode terminal 30 in FIG. 3) is provided with a swaged portion 30c. An end of the negative electrode terminal 40 located inside the outer body 12 (i.e., a lower end of the negative electrode terminal 40 in FIG. 3) is provided with a swaged portion 40c.

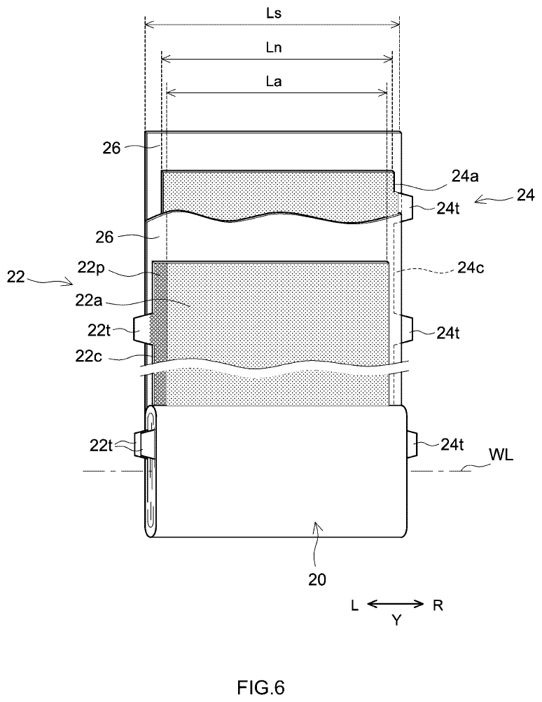

As illustrated in FIG. 3, the positive electrode terminal 30 is electrically connected through the positive electrode collector 50 to a positive electrode 22 (see FIG. 6) of the wound electrode assembly 20 inside the outer body 12. The negative electrode terminal 40 is electrically connected through the negative electrode collector 60 to a negative electrode 24 (see FIG. 6) of the wound electrode assembly 20 inside the outer body 12. The positive electrode terminal 30 is insulated from the sealing plate 14 with an inner insulating member 80 and a gasket 90. The negative electrode terminal 40 is insulated from the sealing plate 14 with another inner insulating member 80 and another gasket 90.

A positive electrode external conductive member 32 and a negative electrode external conductive member 42 each having a plate shape are attached to an outer surface of the sealing plate 14. The positive electrode external conductive member 32 is electrically connected to the positive electrode terminal 30. The negative electrode external conductive member 42 is electrically connected to the negative electrode terminal 40. Electrical components, such as bus bars, through which the storage cells 100 are electrically connected to each other are mounted on the positive electrode external conductive member 32 and the negative electrode external conductive member 42. The positive electrode external conductive member 32 is insulated from the sealing plate 14 with an external insulating member 92. The negative electrode external conductive member 42 is insulated from the sealing plate 14 with another external insulating member 92. Although not illustrated in FIG. 1, adjacent ones of the storage cells 100 are electrically connected to each other during use of the stack 500. For example, assuming that first and second ones of the storage cells 100 are adjacent to each other, the positive electrode external conductive member 32 of the first one of the storage cells 100 and the negative electrode external conductive member 42 of the second one of the storage cells 100 are electrically connected to each other through an electrical component, such as a bus bar. The storage cells 100 of the stack 500 are electrically connected to each other in this manner. The storage cells 100 of the stack 500 may be connected in series or may be connected in parallel. Alternatively, the storage cells 100 of the stack 500 may be connected through “multiple series-parallel connections” combining series and parallel connections.

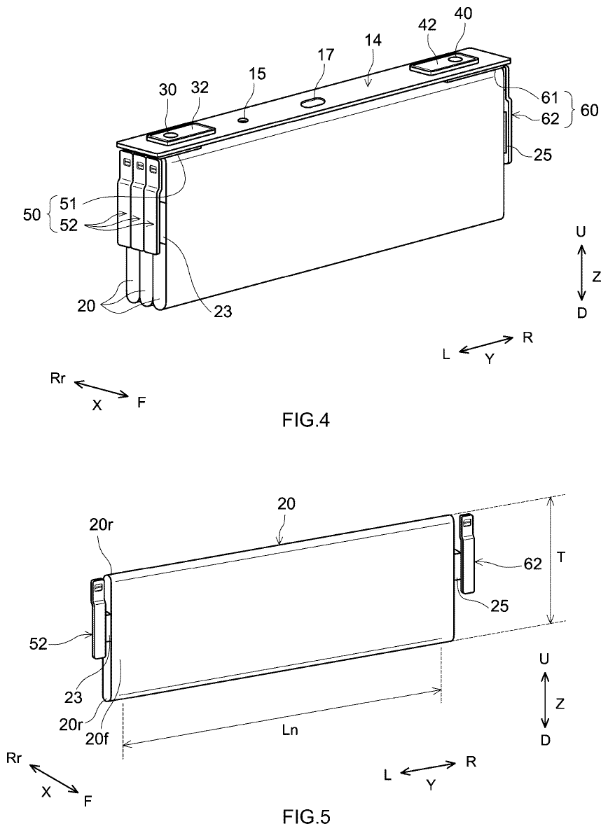

FIG. 4 is a schematic perspective view of the wound electrode assemblies 20 attached to the sealing plate 14. In the present embodiment, the number of wound electrode assemblies 20 disposed inside each outer body 12 is three. Alternatively, any other number of wound electrode assemblies 20 may be disposed inside each outer body 12. The number of wound electrode assemblies 20 disposed in each outer body 12 may be one or may be more than one (i.e., two or more). In the present embodiment, the wound electrode assemblies 20 are electrically connected in parallel. The wound electrode assemblies 20 are disposed inside the outer body 12 such that a winding axis WL (see FIG. 6) is substantially parallel to the long side direction Y. In the present embodiment, the wound electrode assemblies 20 are disposed side by side in the short side direction X in which a thickness direction of the storage cells 100 (i.e., a direction substantially perpendicular to the first side walls 12b of the case 10) corresponds to a thickness direction of the wound electrode assemblies 20. The wound electrode assemblies 20 preferably each have a flat outer shape. End faces of each wound electrode assembly 20 perpendicular or substantially perpendicular to the winding axis WL (i.e., layered surfaces of each electrode 20 defined by end faces of the positive and negative electrodes 22 and 24 placed in layers) face the second side walls 12c. Although not illustrated, an insulating sheet is disposed between the wound electrode assemblies 20 and the outer body 12.

FIG. 5 is a schematic perspective view of one of the wound electrode assemblies 20. In the present embodiment, the wound electrode assemblies 20 housed in the case 10 may be similar in structure. Each wound electrode assembly 20 includes a pair of curved portions (or rounded portions) 20r and a flat portion 20f connecting the pair of curved portions 20r. One of the curved portions 20r (i.e., an upper one of the curved portions 20r in FIG. 5) faces the sealing plate 14. The other one of the curved portions 20r (i.e., a lower one of the curved portions 20r in FIG. 5) faces the bottom 12a of the outer body 12. The flat portion 20f faces the first side walls 12b of the outer body 12. In the present embodiment, the flat portions 20f of the wound electrode assemblies 20 adjacent to each other in the short side direction X face each other.

FIG. 6 is a schematic view of a structure of one of the wound electrode assemblies 20. Each wound electrode assembly 20 includes the positive electrode 22, the negative electrode 24, and separators 26. In the present embodiment, each wound electrode assembly 20 is provided by placing the strip-shaped positive and negative electrodes 22 and 24 in layers, with the strip-shaped separators 26 interposed therebetween, and winding the positive and negative electrodes 22 and 24 and the separators 26 in a longitudinal direction around the winding axis WL. The winding axis WL is substantially parallel to the long side direction Y.

As illustrated in FIG. 6, the positive electrode 22 in the present embodiment includes a positive electrode substrate 22c, a positive electrode active material layer 22a, and a positive electrode protection layer 22p. The positive electrode active material layer 22a and the positive electrode protection layer 22p are fixed onto at least one of surfaces of the positive electrode substrate 22c. The positive electrode protection layer 22p is optional. In other embodiments, the positive electrode 22 may include no positive electrode protection layer 22p. The positive electrode substrate 22c has a strip shape. The positive electrode substrate 22c is preferably made of metallic foil. The positive electrode substrate 22c is more preferably made of aluminum foil or aluminum alloy foil. In the present embodiment, the positive electrode substrate 22c is made of aluminum foil. The positive electrode substrate 22c may have any suitable thickness. The positive electrode substrate 22c preferably has a thickness of between 5 μm and 30 μm, and more preferably has a thickness of between 10 μm and 25 μm. The positive electrode 22 is preferably in 30 layers or more.

One of ends of the positive electrode substrate 22c in the long side direction Y (i.e., a left end of the positive electrode substrate 22c in FIG. 6) is provided with positive electrode tabs 22t. The positive electrode tabs 22t protrude to a first side in the long side direction Y (i.e., leftward in FIG. 6). The positive electrode tabs 22t protrude further to the first side in the long side direction Y than the separators 26. In the present embodiment, the positive electrode tabs 22t are portions of the positive electrode substrate 22c and made of metallic foil (or preferably made of aluminum foil). As illustrated in FIGS. 3 to 6, the positive electrode tabs 22t are placed in layers on a first end of each wound electrode assembly 20 in the long side direction Y (i.e., a left end of each wound electrode assembly 20 in FIGS. 3 to 6) and thus form a positive electrode tab group 23. The positive electrode tab group 23 is electrically connected to the positive electrode terminal 30 through the positive electrode collector 50.

As illustrated in FIG. 6, the positive electrode active material layer 22a has a strip shape extending in a longitudinal direction of the positive electrode substrate 22c. The positive electrode active material layer 22a contains a positive electrode active material that is able to store and release charge carriers in a reversible manner. A lithium transition metal composite oxide, for example, is preferably used as the positive electrode active material. The lithium transition metal composite oxide preferably contains, in particular, nickel (Ni). The positive electrode active material layer 22a may contain any component other than the positive electrode active material. Although any of various components may be added to the positive electrode active material layer 22a, a conductive material and a binder, for example, are preferably added to the positive electrode active material layer 22a. Examples of the binder to be added to the positive electrode active material layer 22a include polyvinylidene fluoride (PVDF). Although any conductive material may be added to the positive electrode active material layer 22a, a carbon material is preferably added to the positive electrode active material layer 22a. The positive electrode active material layer 22a preferably has a density of 3.0 g/cc or more, and more preferably has a density of 3.5 g/cc or more. The positive electrode active material layer 22a preferably has a density of 3.7 g/cc or less.

As illustrated in FIG. 6, the positive electrode protection layer 22p in the present embodiment is provided along a boundary defined between the positive electrode substrate 22c and the positive electrode active material layer 22a in the long side direction Y. The positive electrode protection layer 22p has a strip shape along the positive electrode active material layer 22a. The positive electrode protection layer 22p contains an inorganic filler (e.g., alumina). The positive electrode protection layer 22p may contain any component other than the inorganic filler. Any of various components, such as a conductive material and a binder, may be added to the positive electrode protection layer 22p.

As illustrated in FIG. 6, the negative electrode 24 in the present embodiment includes a negative electrode substrate 24c and a negative electrode active material layer 24a fixed onto at least one of surfaces of the negative electrode substrate 24c. The negative electrode substrate 24c has a strip shape. The negative electrode substrate 24c is preferably made of metallic foil. The negative electrode substrate 24c is more preferably made of copper foil or copper alloy foil. In the present embodiment, the negative electrode substrate 24c is made of copper foil. The negative electrode substrate 24c may have any suitable thickness. The negative electrode substrate 24c preferably has a thickness of between 5 μm and 30 μm, and more preferably has a thickness of between 10 μm and 25 μm.

One of ends of the negative electrode substrate 24c in the long side direction Y (i.e., a right end of the negative electrode substrate 24c in FIG. 6) is provided with negative electrode tabs 24t. The negative electrode tabs 24t protrude to a second side in the long side direction Y (i.e., rightward in FIG. 6). The negative electrode tabs 24t protrude further to the second side in the long side direction Y than the separators 26. In the present embodiment, the negative electrode tabs 24t are portions of the negative electrode substrate 24c and made of metallic foil (or preferably made of copper foil). As illustrated in FIGS. 3 to 6, the negative electrode tabs 24t are placed in layers on a second end of each wound electrode assembly 20 in the long side direction Y (i.e., a right end of each wound electrode assembly 20 in FIGS. 3 to 6) and thus form a negative electrode tab group 25. The negative electrode tab group 25 is disposed opposite to the positive electrode tab group 23 in the long side direction Y such that the negative electrode tab group 25 and the positive electrode tab group 23 are symmetrical with respect to a symmetry axis (not illustrated) perpendicular or substantially perpendicular to the long side direction Y. The negative electrode tab group 25 is electrically connected to the negative electrode terminal 40 through the negative electrode collector 60.

As illustrated in FIG. 6, the negative electrode active material layer 24a has a strip shape extending in a longitudinal direction of the negative electrode substrate 24c. The negative electrode active material layer 24a contains a negative electrode active material that is able to store and release charge carriers in a reversible manner. Preferred examples of the negative electrode active material include graphite, a silicon material (i.e., a silicon-containing substance), and a mixed oxide thereof. The negative electrode active material layer 24a may contain any component other than the negative electrode active material. Any of various components, such as a binder, a thickener, and a dispersant, may be added to the negative electrode active material layer 24a. Examples of the binder to be added to the negative electrode active material layer 24a include styrene-butadiene rubber (SBR) and carboxymethyl cellulose (CMC). Although any conductive material may be added to the negative electrode active material layer 24a, a carbon material is preferably added to the negative electrode active material layer 24a. The negative electrode active material layer 24a preferably has a density of 1.3 g/cc or more, and more preferably has a density of 1.4 g/cc or more. The negative electrode active material layer 24a preferably has a density of 1.7 g/cc or less.

A length Ln of the negative electrode active material layer 24a in the width direction Y is equal to or longer than a length La of the positive electrode active material layer 22a in the width direction Y. In the present embodiment, the length Ln of the negative electrode active material layer 24a in the width direction Y is preferably 20 cm or more. Although described in detail below, such an arrangement makes it possible to suitably control return of the nonaqueous electrolyte to the wound electrode assembly 20. A ratio of the length Ln to a height T of the wound electrode assembly 20 (i.e., a ratio Ln/T) is preferably between 2.8 and 3.2, where the height T is a length of the wound electrode assembly 20 in a direction perpendicular to the winding axis WL of the wound electrode assembly 20 and perpendicular to the thickness direction X of the wound electrode assembly 20 (i.e., a length of the wound electrode assembly 20 in the up-down direction Z in the present embodiment). The ratio Ln/T may also be hereinafter referred to as an “electrode assembly aspect ratio”. Such an arrangement makes it possible to suitably control return of the nonaqueous electrolyte to the wound electrode assembly 20. As used herein, the term “height T of the wound electrode assembly 20” refers to a distance between an uppermost end of one of the curved portions 20r (i.e., the upper curved portion 20r in FIG. 5) of each wound electrode assembly 20 and a lowermost end of the other curved portion 20r (i.e., the lower curved portion 20r in FIG. 5) of each wound electrode assembly 20 in the up-down direction Z.

The separators 26 insulate the positive electrode active material layer 22a of the positive electrode 22 from the negative electrode active material layer 24a of the negative electrode 24. One of the separators 26 defines an outer surface of the wound electrode assembly 20. A length Ls of each separator 26 in the long side direction Y is equal to or longer than the length Ln of the negative electrode active material layer 24a in the long side direction Y. Each separator 26 includes a base. Each separator 26 may be provided with a heat-resistant layer that is formed on at least one of surfaces of the base and contains, for example, inorganic particles and a heat-resistant layer binder. Each separator 26 may be provided with an adhesive layer that is formed on at least one of the surfaces of the base and contains an adhesive layer binder. The adhesive layer may contain inorganic particles in addition to the adhesive layer binder. The adhesive layer may have, for example, a dot shape, a stripe shape, a wave shape, a strip shape, a streak shape, a broken line shape, or any combination of these shapes in a plan view. Each separator 26 preferably includes the heat-resistant layer and the adhesive layer, or preferably includes the adhesive layer containing inorganic particles. Although not illustrated, each separator 26 in the present embodiment includes: the heat-resistant layer provided on the surface of the base; and the adhesive layer provided on the heat-resistant layer.

In the present embodiment, the base of each separator 26 is a sheet member of a microporous film. Each separator 26 is preferably made of polyolefin resin. Examples of the polyolefin resin may include polyethylene (PE), polypropylene (PP), and a mixture thereof.

A thickness of each separator 26 is not limited to any particular thickness. When no nonaqueous electrolyte is present in each separator 26, the thickness of each separator 26 is preferably between about 10 μm and about 30 μm. As used herein, the term “thickness of each separator 26” refers to the thickness of each separator 26 including thickness(es) of the adhesive layer and/or the heat-resistant layer when each separator 26 includes the adhesive layer and/or the heat-resistant layer in addition to the base. Unless otherwise specified, the term “thickness of each separator 26” refers to the thickness of each separator 26 before a press forming process is performed.

When each separator 26 includes the adhesive layer, any suitable material known in the related art may be used as the adhesive layer binder to be contained in the adhesive layer. Examples of materials used as the adhesive layer binder include acrylic resin, fluorine resin (e.g., PVDF), rubber resin (e.g., styrene-butadiene rubber (SBR)), urethane resin, silicone resin, and epoxy resin. Any one of these materials may be used alone, or any two or more of these materials may be used in combination. When the adhesive layer contains inorganic particles, the mass percentage of the inorganic particles to the total mass of the adhesive layer is preferably between about 5 percent and about 20 percent, and more preferably between about 10 percent and about 15 percent.

When each separator 26 includes the heat-resistant layer containing inorganic particles, the mass percentage of the inorganic particles to the total mass of the heat-resistant layer is preferably 85 percent or more, more preferably 90 percent or more, and even more preferably 95 percent or more. Any suitable material known in the related art may be used as the heat-resistant layer binder to be contained in the heat-resistant layer. Examples of materials used as the heat-resistant layer binder include acrylic resin, fluorine resin, epoxy resin, urethane resin, and ethylene vinyl acetate resin. Any one of these materials may be used alone, or any two or more of these materials may be used in combination. The same type of material or different types of material may be used as the heat-resistant layer binder and the adhesive layer binder.

Any inorganic particles known in the related art may be contained in the heat-resistant layer and the adhesive layer of each separator 26. Preferred examples of the inorganic particles include insulating ceramic particles. From the viewpoint of enhancing heat resistance, preferable examples of the inorganic particles include particles of inorganic oxides (such as alumina, zirconia, silica, and titania), metallic hydroxides (such as aluminum hydroxide), and clay minerals (such as boehmite). Particles of alumina and/or boehmite, in particular, are preferably used as the inorganic particles. From the viewpoint of preventing thermal contraction of the separators 26, particles of an aluminum-containing compound, in particular, are preferably used as the inorganic particles.

As illustrated in FIG. 3, the positive electrode collector 50 defines a conduction path through which the positive electrode tab group 23 including the positive electrode tabs 22t is electrically connected to the positive electrode terminal 30. The positive electrode collector 50 includes a first positive electrode collector portion 51 and second positive electrode collector portions 52. The first positive electrode collector portion 51 is attached to an inner surface of the sealing plate 14. The second positive electrode collector portions 52 extend along an associated one of the second side walls 12c of the outer body 12. As illustrated in FIGS. 3 to 5, the second positive electrode collector portions 52 are each attached to an associated one of the wound electrode assemblies 20.

As illustrated in FIG. 3, the negative electrode collector 60 defines a conduction path through which the negative electrode tab group 25 including the negative electrode tabs 24t is electrically connected to the negative electrode terminal 40. The negative electrode collector 60 includes a first negative electrode collector portion 61 and second negative electrode collector portions 62. The first negative electrode collector portion 61 may be similar in arrangement to the first positive electrode collector portion 51 of the positive electrode collector 50. The second negative electrode collector portions 62 may be similar in arrangement to the second positive electrode collector portions 52 of the positive electrode collector 50.

### Method for Manufacturing Stack 500

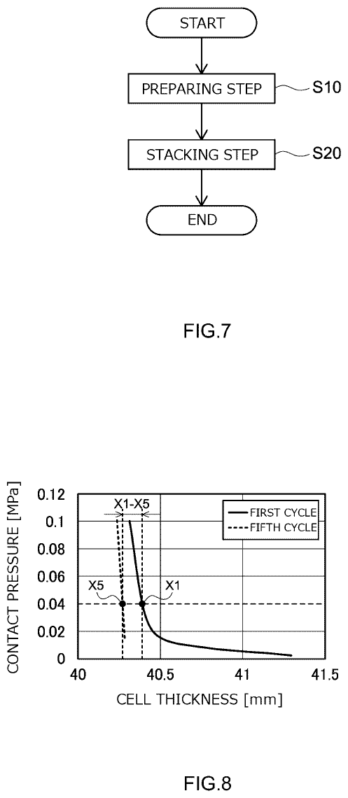

The present disclosure provides a method for manufacturing the stack 500 (which will hereinafter be referred to as a “stack manufacturing method”). FIG. 7 is a flow chart of the stack manufacturing method according to the present embodiment. The stack 500 disclosed herein is manufacturable by the stack manufacturing method including a preparing step S10 and a stacking step S20. The stack manufacturing method disclosed herein is characterized by including the preparing step S10. The stack manufacturing method disclosed herein may include, in addition to these steps, any other step at any stage. The stack manufacturing method disclosed herein may include any manufacturing process known in the related art.

### Preparing Step S10

The preparing step S10 involves preparing the storage cells 100 each including the wound electrode assembly 20, the nonaqueous electrolyte, and the case 10, which have been described above. The preparing step S10 may involve preparing the storage cells 100 by purchasing equivalent products or manufacturing the storage cells 100.

When each storage cell 100 prepared in the preparing step S10 undergoes five cycles of a process involving applying a load of up to 0.1 MPa to each storage cell 100 at a speed of 0.1 mm/min in the thickness direction of each storage cell 100 (i.e., the direction X in FIG. 1) and then reducing the load to 0.01 MPa at a speed of 0.1 mm/min, a relationship between a storage cell thickness X1 determined relative to a contact pressure of 0.04 MPa by a pressurized side F-s curve in a first cycle and a storage cell thickness X5 determined relative to a contact pressure of 0.04 MPa by a pressurized side F-s curve in a fifth cycle satisfies the following expression: (X1−X5)/X1×100≥0.3. As used herein, “(X1−X5)/X1×100” may also be referred to as a “cell thickness change rate”. In the present embodiment, the cell thickness change rates are measured by an autograph (precision universal testing machine).

FIG. 8 is a graph illustrating exemplary F-s curves obtained in the preparing step S10 according to the present embodiment. The F-s curve in the first cycle is equivalent to an F-s curve of a storage cell at the time of shipment (i.e., before use of a stack). The F-s curve in the fifth cycle is equivalent to an F-s curve of a storage cell in which nonaqueous electrolytes retained in wound electrode assemblies have been removed. Accordingly, a difference between X1 and X5 (i.e., X1−X5) is equivalent to a thickness of nonaqueous electrolytes retained in wound electrode assemblies at the time of shipment. As used herein, the term “cell thickness change rate” refers to a rate of decrease in cell thickness at a contact pressure of 0.04 MPa. The cell thickness change rates each serve as an indicator of the amount of nonaqueous electrolyte retained in wound electrode assemblies.

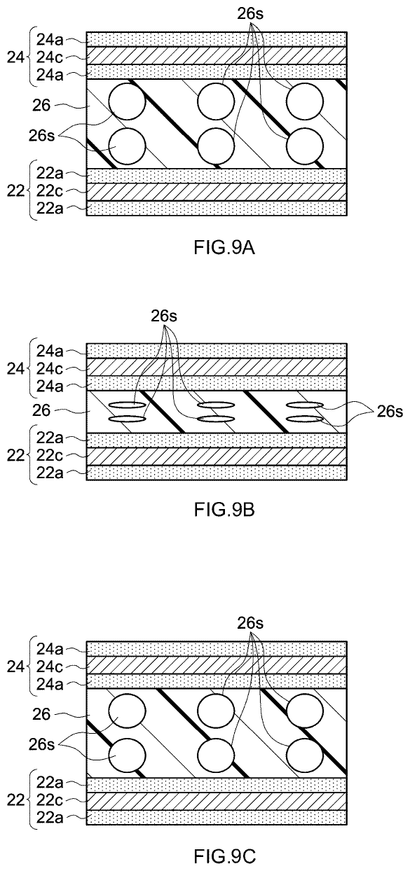

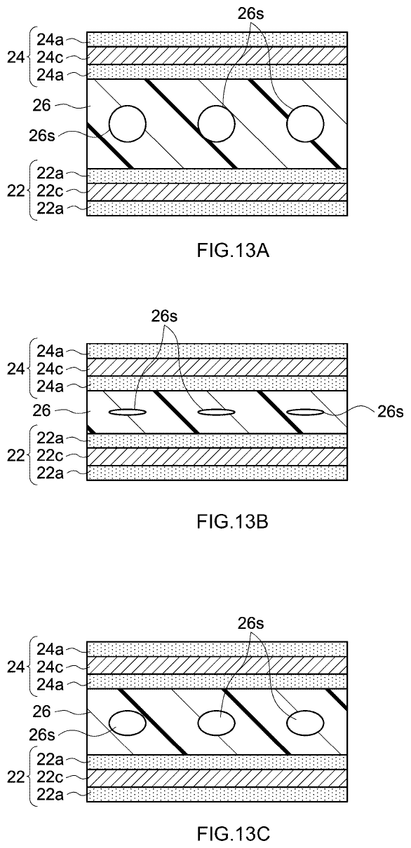

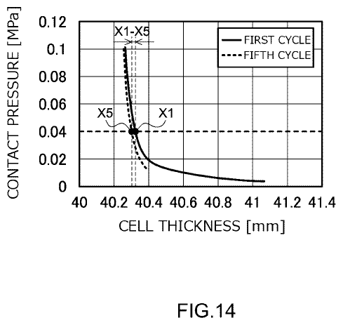

FIGS. 9A to 9C are schematic diagrams illustrating how the wound electrode assembly 20 according to the present embodiment changes in thickness. FIGS. 13A to 13C are schematic diagrams illustrating how a wound electrode assembly 20 according to a conventional example changes in thickness. FIGS. 9A and 13A each illustrate the wound electrode assembly 20 before the storage cells 100 of the stack 500 are restrained. FIGS. 9B and 13B each illustrate the wound electrode assembly 20 while the storage cells 100 of the stack 500 are restrained. FIGS. 9C and 13C each illustrate the wound electrode assembly 20 when the nonaqueous electrolyte has returned to the wound electrode assembly 20. FIG. 14 is a graph illustrating an exemplary F-s curve according to the conventional example. FIG. 14 is equivalent to FIG. 8. Each of FIGS. 9A to 9C and FIGS. 13A to 13C is an enlarged view of a portion of the wound electrode assembly 20.

When the nonaqueous electrolytes are present in the wound electrode assemblies 20, the nonaqueous electrolytes are present, for example, in voids 26s of the separators 26 of the wound electrode assemblies 20. In the state illustrated in FIG. 13A, the storage cells 100 before being restrained retain the nonaqueous electrolytes in the voids 26s of the wound electrode assemblies 20. During stack manufacturing, restraining the storage cells 100 applies a load to the storage cells 100 in the thickness direction X. The load compresses the voids 26s of the wound electrode assemblies 20 as illustrated in FIG. 13B, with the result that the nonaqueous electrolytes retained in the voids 26s are pushed out of the wound electrode assemblies 20. During use of the stack 500, the thicknesses of the wound electrode assemblies 20 decrease, for example, at the time of initial charging, in a low temperature environment, or in a low SOC condition. In particular, when the stack 500 is used in a low temperature environment and in a low SOC condition at the time of initial charging, the thicknesses of the wound electrode assemblies 20 decrease significantly. In such a case, the restraining load applied to the storage cells 100 by the restrainer 300 decreases. Then, as illustrated in FIG. 13C, the nonaqueous electrolytes outside the wound electrode assemblies 20 will return again into the wound electrode assemblies 20 in response to the decrease in restraining load. The amount of nonaqueous electrolyte that returns again into each wound electrode assembly 20 depends on the volume of voids 26s in each wound electrode assembly 20. In other words, when the volume of voids 26s in each wound electrode assembly 20 of the storage cells 100 is small, the amount of nonaqueous electrolyte that returns again into each wound electrode assembly 20 is small. As illustrated in FIG. 14, the storage cells 100 known in the art each have a small difference between X1 and X5. In other words, the volume of voids 26s, through which the nonaqueous electrolyte present outside each wound electrode assembly 20 returns again into each wound electrode assembly 20, is small in the conventional example. Thus, if the volume of voids 26s in each wound electrode assembly 20 of the storage cells 100 is small, the amount of nonaqueous electrolyte that returns to each wound electrode assembly 20 is small, making it difficult to successfully increase the thickness of each wound electrode assembly 20, so that the thickness of each storage cell 100 remains small. This results in a reduction in load applied to the storage cells 100, making it impossible to restrain the storage cells 100 by applying a sufficient load thereto.

The stack manufacturing method according to the present embodiment is characterized by including the preparing step S10 involving preparing the storage cells 100 each having a cell thickness change rate of 0.3% or more (i.e., preparing the storage cells 100 such that (X1−X5)/X1×100≥0.3). The storage cells 100 prepared in the preparing step S10 each have a sufficient difference between X1 and X5. In other words, as illustrated in FIG. 9A, the wound electrode assemblies 20 each have a sufficient thickness due to presence of the nonaqueous electrolyte that has been retained in each wound electrode assembly 20 at the time of shipment. As illustrated in FIG. 9C, the wound electrode assemblies 20 each have a sufficient volume of voids 26s through which the nonaqueous electrolyte present outside each wound electrode assembly 20 returns again into each wound electrode assembly 20. Each wound electrode assembly 20 thus increases in thickness by capturing the nonaqueous electrolyte again, which increases the thicknesses of the storage cells 100. Accordingly, the stack manufacturing method according to the present embodiment reduces a decrease in the load applied to the storage cells 100, with the result that the load applied to the storage cells 100 of the stack 500 is maintained at a sufficient level.

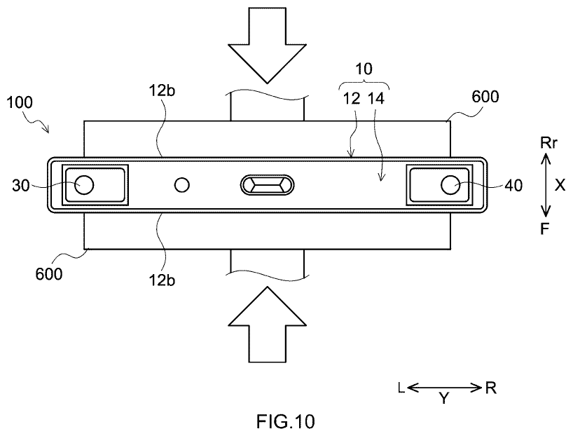

FIG. 10 is a schematic diagram illustrating a cell thickness change rate measuring process in the preparing step S10. The open arrows in FIG. 10 indicate a direction in which an autograph 600 applies a load to the storage cell 100. As indicated by the open arrows in FIG. 10, the autograph 600 applies a load to the storage cell 100 in its thickness direction. As illustrated in FIG. 10, the measuring process first involves setting the storage cell 100 to the autograph 600 such that a load is to be applied to the storage cell 100 in its thickness direction (i.e., in the direction indicated by the open arrows). As illustrated in FIG. 10, the storage cell 100 is set to the autograph 600 such that the pair of first side walls 12b of the storage cell 100 come into contact with the autograph 600. The storage cell 100 is set to the autograph 600 such that the autograph 600 applies a load to the flat portion 20f (see FIG. 5) of each wound electrode assembly 20 included in the storage cell 100. In the present embodiment, the storage cell 100 is set to the autograph 600 such that a load is to be applied to an area indicated by the thick chain line in FIG. 3. A change in the thickness of each storage cell 100 may be measured by any method or device. In one example, a laser displacement sensor (such as a KEYENCE's LK-G157 laser displacement sensor) or other displacement sensor may be used. The thickness of each storage cell 100 may be measured at a single position or more than one position (i.e., two or more positions). The measuring process then involves applying a load to the storage cell 100 in its thickness direction (i.e., in the direction indicated by the open arrows in FIG. 10) at a speed of 0.1 mm/min. The measuring process involves, when the load has reached 0.1 MPa, reducing the load to 0.01 MPa at a speed of 0.1 mm/min. The storage cell 100 undergoes five cycles of the process just described. Pressurized side F-s curves (i.e., load displacement curves) in first and fifth cycles are then obtained (see FIG. 8). In accordance with the F-s curve in the first cycle, a thickness of the storage cell 100 when a load of 0.04 MPa is applied thereto in the first cycle is plotted and defined as a storage cell thickness X1. In accordance with the F-s curve in the fifth cycle, a thickness of the storage cell 100 when a load of 0.04 MPa is applied thereto in the fifth cycle is plotted and defined as a storage cell thickness X5. The cell thickness change rate (%) is calculated using Expression (i) below.

$$( X 1 - X 5 ) / X 1 \times 100 \qquad Expression ( i )$$

The numerical range of the cell thickness change rate of each storage cell 100 may be controlled by any of various suitable methods. The cell thickness change rate of each storage cell 100 may be controlled by adjusting, for example, the volume of voids 26s in each separator 26 and/or the size of each wound electrode assembly 20.

The numerical range of the cell thickness change rate of each storage cell 100 may be controlled by, for example, adjusting the length Ln of the negative electrode active material layer 24a (which is included in each wound electrode assembly 20) in the width direction Y. In this case, the length Ln of the negative electrode active material layer 24a in the width direction Y is preferably 20 cm or more. This makes it possible to suitably control entrance and exit of the nonaqueous electrolyte to and from the inside of each wound electrode assembly 20 so as to control the numerical range of the cell thickness change rate of each storage cell 100. The numerical range of the cell thickness change rate of each storage cell 100 may also be controlled by adjusting the ratio Ln/T (i.e., the electrode assembly aspect ratio), which is the ratio of the length Ln of the negative electrode active material layer 24a in the width direction Y to the height T of the wound electrode assembly 20. In this case, the electrode assembly aspect ratio is preferably between 2.8 and 3.2. This also makes it possible to suitably control entrance and exit of the nonaqueous electrolyte to and from the inside of each wound electrode assembly 20.

For example, when each separator 26 is provided on its surface with the adhesive layer, the numerical range of the cell thickness change rate of each storage cell 100 may be controlled by adjusting the percentage of an area of a region where the adhesive layer is to be formed (hereinafter referred to as an “adhesive layer formation area”). The percentage of the adhesive layer formation area is calculated by the following expression: Adhesive Layer Formation Area/Separator Area×100. In this case, the percentage of the adhesive layer formation area is preferably between about 3% and about 30%, and more preferably between about 5% and about 15%. The adhesive layer is preferably applied in a dot pattern to the surface of each separator 26. This makes it possible to suitably increase the volume of voids 26s in each separator 26 so as to increase the amount of nonaqueous electrolyte to be retained. The percentage of a volume of the adhesive layer to a volume of a portion of each wound electrode assembly 20 between the electrode (i.e., the positive or negative electrode) and the base of the separator 26 is preferably between 50 vol % and 97 vol %, and more preferably between 85 vol % and 95 vol %. This percentage is calculated by the following expression: Volume of Adhesive Layer of Separator/Volume of Portion of Wound Electrode assembly between Electrode and Separator Base×100. Using the wound electrode assemblies 20 whose adhesive layers meet these conditions also makes it possible to suitably control the numerical range of the cell thickness change rate of each storage cell 100.

The numerical range of the cell thickness change rate of each storage cell 100 may also be controlled by adjusting, for example, a particle size (D50) of the inorganic particles contained in the adhesive layers and the heat-resistant layers. In this case, the particle size (D50) of the inorganic particles contained in the adhesive layers and the heat-resistant layers is preferably between about 0.1 μm and about 0.6 μm. As used herein, the term “particle diameter (D50) of the inorganic particles” refers to an average particle size for a cumulative total of 50 wt % of the inorganic particles in increasing order of particular size in a particle size distribution measured by a laser diffraction method.

The preparing step S10 may involve preparing the storage cells 100 whose cell thickness change rates fall within the numerical range of 0.3% or more (≥0.3), or may involve measuring the cell thickness change rates in the above-described manner so as to check that the cell thickness change rates of the storage cells 100 fall within the numerical range of 0.3% or more (≥0.3).

Any suitable upper limit may be set to the cell thickness change rates. The thickness of each storage cell 100 before being restrained (or before being stacked) increases in accordance with an increase in cell thickness change rate. Accordingly, the cell thickness change rates are preferably 2.0% or less from the viewpoint of reducing the size of an assembling device in the stacking step S20 and saving labor in the stacking step S20.

### Stacking Step S20

The stacking step S20 involves stacking the storage cells 100 in the thickness direction X of the storage cells 100. The stacking step S20 may be similar to that performed in any stack manufacturing method known in the related art. In the present embodiment, the storage cells 100 are sandwiched between the pair of end plates 310 in the thickness direction X and restrained with the side plates 320 and the screws 330. The restrainer 300 thus applies a restraining load to the storage cells 100 in a stacking direction. Performing the stacking step S20 in this manner completes manufacture of the stack 500 according to the present embodiment. The restraining load during cell stacking in the stacking step S20 may be, for example, between 2 kN and 30 kN and is preferably between 3 kN and 20 kN.

### Method for Manufacturing Storage Cell 100

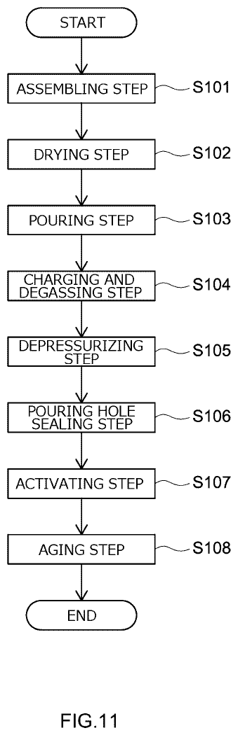

A method for manufacturing the storage cells 100 will hereinafter be referred to as a “storage cell manufacturing method”. Although the storage cells 100 prepared in the preparing step S10 may be manufactured by any manufacturing method, the storage cells 100 prepared in the preparing step S10 may be manufactured, for example, by the storage cell manufacturing method described below. In other words, the storage cell manufacturing method described below is an example of the preparing step S10. FIG. 11 is a flow chart of the storage cell manufacturing method according to the present embodiment. As illustrated in FIG. 11, the storage cells 100 may be manufactured by a manufacturing method including, for example, an assembling step S101, a drying step S102, a pouring step S103, a charging and degassing step S104, a depressurizing step S105, a pouring hole sealing step S106, an activating step S107, and an aging step S108 typically in this order. Alternatively, the storage cells 100 may be manufactured by performing these steps in any other suitable order. The storage cell manufacturing method disclosed herein may include, in addition to these steps, any other step at any stage. The storage cell manufacturing method disclosed herein may include any manufacturing process known in the related art.

### Assembling Step S101

The assembling step S101 involves placing the wound electrode assemblies 20 inside the case 10 (or more specifically, inside the outer body 12) so as to prepare a cell assembly. As used herein, the term “cell assembly” refers to a storage cell assembled to a form that is yet to undergo the pouring hole sealing step S106 described below.

The assembling step S101 involves attaching the second positive electrode collector portions 52 of the positive electrode collector 50 to the positive electrode tab groups 23 of the wound electrode assemblies 20, and attaching the second negative electrode collector portions 62 of the negative electrode collector 60 to the negative electrode tab groups 25 of the wound electrode assemblies 20. The assembling step S101 subsequently involves attaching the positive electrode terminal 30 and the negative electrode terminal 40 to the sealing plate 14. The assembling step S101 then involves connecting the positive electrode terminal 30 to the first positive electrode collector portion 51 and connecting the negative electrode terminal 40 to the first negative electrode collector portion 61 by using a method known in the art (e.g., ultrasonic bonding, resistance welding, or laser welding). The assembling step S101 subsequently involves placing the wound electrode assemblies 20 inside an insulating sheet. The insulating sheet may be prepared by folding an insulating resin sheet (which is made of, for example, a resin material, such as polyethylene (PE)) into a bag shape or a box shape. The wound electrode assemblies 20 covered with the insulating sheet are preferably housed in (or inserted into) an internal space of the outer body 12. The assembling step S101 then involves connecting the outer body 12 of the case 10 to the sealing plate 14 so as to fabricate the cell assembly. The outer body 12 of the case 10 may be connected to the sealing plate 14 by, for example, welding, such as laser welding. The assembling step S101 does not involve sealing the pouring hole 15.

The assembling step S101 preferably involves disposing the wound electrode assemblies 20 inside the outer body 12 such that the wound electrode assemblies 20 are side by side in the short side direction X in which the thickness direction of the storage cell 100 (i.e., a direction substantially perpendicular to the first side walls 12b of the case 10) and the thickness direction of each wound electrode assembly 20 corresponds to each other. In other words, the assembling step S101 preferably involves disposing the wound electrode assemblies 20 inside the outer body 12 such that the winding axis WL is parallel or substantially parallel to the bottom 12a of the outer body 12.

### Drying Step S102

The drying step S102 involves drying the cell assembly so as to remove moisture contained in the cell assembly (e.g., moisture inside each wound electrode assembly 20). The drying step S102 may be performed by any known method. In one example, the drying step S102 may be performed by conveying the cell assembly (i.e., the case 10 housing the wound electrode assemblies 20) to a drying furnace (not illustrated) and then heating the cell assembly.

A drying temperature and a drying time during the drying step S102 may be adjusted suitably in accordance with, for example, the amount of moisture contained in each wound electrode assembly 20. The drying temperature may be any temperature at which the moisture contained in each wound electrode assembly 20 is removable. The cell assembly is desirably dried at a temperature that does not damage the separators 26 of the wound electrode assemblies 20. The drying step S102 is preferably carried out in a depressurized atmosphere. This makes it possible to reduce the drying time in the drying step S102. The drying step S102, however, may be carried out in any other suitable atmosphere. The drying step S102 may be carried out in an atmospheric pressure atmosphere. In the present disclosure, the drying step S102 is an optional step. The drying step S102 may be skipped in other preferable embodiments.

### Pouring Step S103

The pouring step S103 involves pouring, through the pouring hole 15 provided in the sealing plate 14, the nonaqueous electrolyte into the case 10 in which the wound electrode assemblies 20 are housed. Although the pouring step S103 may be carried out in an atmospheric pressure atmosphere or a depressurized atmosphere, the pouring step S103 is preferably carried out in a depressurized atmosphere. This facilitates penetration of the wound electrode assemblies 20 by the nonaqueous electrolyte, making it possible to finish the pouring step S103 in a shorter period of time. The pouring step S103 involves pouring the nonaqueous electrolyte into the case 10 such that the nonaqueous electrolyte spreads through an entirety of each wound electrode assembly 20. The pouring step S103 may be performed by using, when necessary, any nonaqueous electrolyte pouring device known in the related art. Examples of a pressure-feeding gas that may be used to pressure-feed the nonaqueous electrolyte during the pouring step S103 include an inert gas (such as nitrogen (N₂)) and dry air, as is known in the related art. Upon end of the pouring step S103, the inside of the case 10 is preferably pressurized and/or depressurized when necessary.

### Charging and Degassing Step S104

The charging and degassing step S104 involves charging the cell assembly. This makes it possible to form films on surfaces of the negative electrode active material layers 24a. The charging and degassing step S104 further involves discharging gas, which is generated by charging and discharging, out of the case 10. This makes it possible to reduce the amount of gas that will be generated inside the case 10 after sealing the pouring hole 15 and to reduce the amount of gas that will remain inside the wound electrode assemblies 20 after sealing the pouring hole 15. Charging conditions in the charging and degassing step S104 may be any suitable conditions and may be similar to those known in the related art. In one example, the charging and degassing step S104 may involve charging the cell assembly with a current of between about 0.05 C and about 10 C in a room temperature atmosphere (e.g., at a temperature of 25° C.) until the state-of-charge (SOC) of the cell assembly reaches a level of between about 20% and about 90%.

The charging and degassing step S104 is preferably performed, with the cases 10 restrained such that a load is applied to the cases 10. Gas in the cases 10 is thus likely to be pushed out of the cases 10, making it possible to reduce or prevent gas entrainment in the wound electrode assemblies 20. When the cases 10 are restrained in the charging and degassing step S104, a load is preferably applied to the first side walls 12b of the cases 10. The cases 10 are preferably restrained such that, in a front view of the first side walls 12b of the cases 10, a central point CP (see FIG. 3) of the wound electrode assemblies 20 substantially corresponds to a central point of restrained regions of the first side walls 12b. Although the restrained regions may be any suitable regions, the restrained regions are preferably regions of the first side walls 12b of the cases 10 centering around the central point CP of the wound electrode assemblies 20 and having a length of between 280 mm and 295 mm in the long side direction Y and a length of between 85 mm and 95 mm in the up-down direction Z. Although any suitable load may be applied to the cases 10, a load of between 0.25 MPa and 0.80 MPa is preferably applied to the cases 10. As used herein, the term “central point CP of the wound electrode assemblies 20” refers to a point at which an imaginary line MY defining a center of each wound electrode assembly 20 in the long side direction Y and an imaginary line MZ defining a center of each wound electrode assembly 20 in the up-down direction Z intersect with each other at right angles on a surface of the flat portion 20f of each wound electrode assembly 20 (i.e., on a surface of each wound electrode assembly 20 facing the first side wall 12b of the case 10) as illustrated in FIG. 3.

### Depressurizing Step S105

The depressurizing step S105 involves depressurizing the inside of the case 10 such that gas present inside the case 10 (e.g., air and/or the gas generated during the charging and degassing step S104) is further discharged out of the case 10. The depressurizing step S105 may be similar to those included in storage cell manufacturing methods known in the related art. The depressurizing step S105 does not particularly characterize the present disclosure and will thus not be described in further detail. In the present disclosure, the depressurizing step S105 is an optional step. The depressurizing step S105 may be skipped in other preferred embodiments.

### Pouring Hole Sealing Step S106

The pouring hole sealing step S106 involves sealing the pouring hole 15 of the cell assembly. The pouring hole sealing step S106 may be similar to those included in storage cell manufacturing methods known in the related art or may be performed in any suitable manner. In the present embodiment, the pouring hole sealing step S106 involves sealing the pouring hole 15 with the sealing member 16 made of metal by welding a metallic portion of the sealing member 16 to the sealing plate 14 (or more specifically, a portion of the sealing plate 14 defining a peripheral edge of the pouring hole 15). The pouring hole 15, however, may be sealed in any other suitable manner. Although not illustrated, the pouring hole 15 may be sealed with, for example, a rivet, such as a blind rivet.

### Activating Step S107

The activating step S107 involves charging the storage cell 100 whose pouring hole 15 is sealed by the pouring hole sealing step S106, while applying a load to the storage cell 100 in its thickness direction. This forms films on the surfaces of the negative electrode active material layers 24a. In the present disclosure, the activating step S107 may be an exemplary sub-step included in the preparing step S10.

Charging conditions in the activating step S107 may be any suitable conditions and may be similar to those known in the related art. In one example, the activating step S107 may involve charging the storage cell 100 with a current of between about 0.05 C and about 10 C in a room temperature atmosphere (e.g., at a temperature of 25° C.) until the state-of-charge (SOC) of the storage cell 100 reaches a level of between about 20% and about 90%.

The activating step S107 preferably involves applying a load of between about 0.5 MPa and about 0.7 MPa to the storage cell 100. This allows the cell thickness change rate of the storage cell 100 to fall within a suitable range (e.g., the range of between 0.051% and 0.055%). The load may be applied to the storage cell 100 in any suitable manner. The load may be applied to the storage cell 100 by any common tool(s), device(s), and/or process(es) usable in storage cell manufacturing methods known in the related art. In one example, the pair of first side walls 12b of the storage cell 100 may be sandwiched between restraining plates, and the restraining plates may be connected with bridge member(s) so as to apply the load to the storage cell 100.

### Aging Step S108

The aging step S108 involves placing the storage cell 100 (which has undergone the activating step S107) in storage for a predetermined period of time in a predetermined temperature environment while keeping the storage cell 100 charged. This makes it possible to more suitably form films on the surfaces of the negative electrode active material layers 24a. In the present disclosure, the aging step S108 is an optional step. The aging step S108 may be skipped in other preferred embodiments.

Conditions in the aging step S108 may be adjusted when necessary in accordance with a film forming mode required and are thus not limited to any particular conditions. In one example, a cell temperature (i.e., an aging temperature) in the aging step S108 may be 30° C. or more, may preferably be 40° C. or more, may more preferably be 50° C. or more, and may even more preferably be 60° C. or more. Although any upper limit may be set to the aging temperature, the upper limit may be, for example, about 70° C. or less. In the aging step S108, a constant-temperature bath, for example, may be used for temperature control. A period of time during which the aging step S108 is to be performed (i.e., an aging time) may be changed when necessary in accordance with, for example, the aging temperature and is thus not limited to any particular period of time. In one example, when the aging temperature is between about 45° C. and about 65° C., the aging time is preferably between about 3 hours and about 30 hours.

The aging step S108 preferably involves performing aging while applying a load to the storage cell 100 in the thickness direction X. Although any suitable load may be applied to the storage cell 100 in the aging step S108, a load of between 0.5 MPa and 0.7 MPa is preferably applied to the storage cell 100 in the aging step S108. Alternatively, the storage cell manufacturing method may involve making a transition from the activating step S107 to the aging step S108 while maintaining the load applied to the storage cell 100 in the activating step S107.

The stack 500 is usable for various purposes. The stack 500 is suitably usable as a motor power source (e.g., a driving power source) to be installed on, for example, a vehicle (such as a passenger car or a truck). The stack 500 may be installed on any type of vehicle, examples of which include, but are not limited to, a plug-in hybrid electric vehicle (PHEV), a hybrid electric vehicle (HEV), and a battery electric vehicle (BEV).

Examples 1 and 2 of the present disclosure and Comparative Examples 1 to 3 will be described below. These examples, however, are not intended to limit the present disclosure.

### Preparation of Storage Cells

First, three storage cells were prepared to manufacture a stack according to Example 1. Wound electrode assemblies housed in each of the storage cells according to Example 1 were each fabricated by placing strip-shaped positive and negative electrodes and strip-shaped separators in alternating layers and winding the positive and negative electrodes and the separators around a winding axis. The wound electrode assemblies fabricated in this manner each include a pair of curved portions similar to those illustrated in FIG. 5. The separators used in Example 1 were provided such that the separators each include an adhesive layer and a heat-resistant layer, the percentage of an adhesive layer formation area is 30%, and inorganic particles contained in the heat-resistant layer have a particle size of 0.5 μm. A length Ln of a negative electrode active material layer (which is included in each wound electrode assembly according to Example 1) in a width direction is 29 cm. The wound electrode assemblies were fabricated such that an electrode assembly aspect ratio Ln/T (which is a ratio of the length Ln of the negative electrode active material layer in the width direction to a height T of each wound electrode assembly) is 3.0. The positive electrode of each wound electrode assembly was in 33 layers.

In Example 2, separators were each provided such that the percentage of an adhesive layer formation area is 7%, and inorganic particles contained in an adhesive layer have a particle size of 0.3 μm. Except for these points, storage cells according to Example 2 are similar to the storage cells according to Example 1. In Example 2, the number of storage cells prepared was three.

In Comparative Example 1, separators were each provided such that the percentage of an adhesive layer formation area is 100%, and inorganic particles contained in an adhesive layer have a particle size of 10 μm. Except for these points, storage cells according to Comparative Example 1 are similar to the storage cells according to Example 1. In Comparative Example 1, the number of storage cells prepared was three. In Comparative Example 2, separators similar to those according to Comparative Example 1 were used, and an activating step involved charging and discharging each storage cell while applying a load of 0.4 MPa to each storage cell in its thickness direction. Except for these points, the storage cells according to Comparative Example 2 are similar to the storage cells according to Example 1. In Comparative Example 2, the number of storage cells prepared was three. In Comparative Example 3, electrode assemblies each have a “stacked structure” in which substantially rectangular positive and negative electrodes and substantially rectangular separators are stacked in alternating layers in a thickness direction of a storage cell. In other words, the electrode assemblies according to Comparative Example 3 are not wound electrode assemblies. The electrode assemblies according to Comparative Example 3 each have an aspect ratio of 1.6. A case of each storage cell according to Comparative Example 3 was changed in shape in accordance with the changes made to the electrode assemblies, although the case of each storage cell according to Comparative Example 3 was not changed in thickness or material. An activating step according to Comparative Example 3 involved charging and discharging each storage cell while applying a load of 0.18 MPa to each storage cell in its thickness direction. Except for these points, the storage cells according to Comparative Example 3 are similar to the storage cells according to Example 1. In Comparative Example 3, the number of storage cells prepared was three.

### Calculation of Cell Thickness Change Rates

Cell thickness change rates of the storage cells according to Examples 1 and 2 and Comparative Examples 1 to 3 were measured by the previously described process. An autograph used for this measurement was a precision universal testing machine (AGX-V series autograph) available from SHIMADZU CORPORATION. Cell thicknesses were measured by using a laser displacement sensor (LK-G157) available from KEYENCE CORPORATION. A cell thickness measuring process first involved setting each storage cell to the autograph as illustrated in FIG. 10. The process then involved applying a load to the storage cell in its thickness direction (i.e., the direction indicated by the open arrows in FIG. 10) at a speed of 0.1 mm/min until the load applied to the storage cell reaches 0.1 MPa. The process then involved reducing the load to 0.01 MPa at a speed of 0.1 mm/min. The storage cell undergoes five cycles of the process just described. Thus, F-s curves (i.e., load displacement curves) in first and fifth cycles were obtained. Assume that a thickness of each storage cell determined relative to a contact pressure of 0.04 MPa by the F-s curve obtained in the first cycle is a storage cell thickness X1 and a thickness of each storage cell determined relative to a contact pressure of 0.04 MPa by the F-s curve obtained in the fifth cycle is a storage cell thickness X5. In this case, the cell thickness change rate (%) of each storage cell was calculated by Eq. (i) below. Table 1 below lists results of the calculation.

$$Cell Thickness Change Rate ( \% ) = ( X 1 - X 5 ) / X 1 \times 100 \qquad Eq . ( i )$$

TABLE 1
Table 1

| | Electrode | Electrode Assembly | Load Applied in | Cell Thickness | 0.3 to 3 kN Spring |
|---|---|---|---|---|---|
| | Structure | Aspect Ratio | Activating Step (MPa) | Change Rate (%) | Constant (kN/mm) |
| Example 1 | Wound | 3.0 | 0.60 | 0.30 | 7.47 |
| Example 2 | Wound | 3.0 | 0.60 | 1.47 | 3.75 |
| Comparative Example 1 | Wound | 3.0 | 0.60 | 0.06 | 27.37 |
| Comparative Example 2 | Wound | 3.0 | 0.40 | 0.11 | 24.15 |
| Comparative Example 3 | Stacked | 1.6 | 0.18 | 0.20 | 19.35 |

### 0.3 to 3 kN Spring Constant

A “0.3 to 3 kN spring constant” was calculated for each of the storage cells according to Examples 1 and 2 and Comparative Examples 1 to 3. As used herein, the term “0.3 to 3 kN spring constant” refers to an indicator of how much a stack restraining load is lost during a reduction in cell thickness. A graph was created based on the F-s curves obtained. Specifically, the graph plots cell thickness changes between the first cycle and the fifth cycle under the same load conditions, where the horizontal axis represents A cell thicknesses (mm) and the vertical axis represents applied loads (kN). A spring constant when a load range was between 0.3 kN and 3 kN was calculated to be the “0.3 to 3 kN spring constant (kN/mm)”. The “0.3 to 3 kN spring constant” was calculated using Eq. (ii) below. Results of the calculation are given in Table 1.

$$0.3 to 3 kN Spring Constant ( kN / mm ) = - ( ( 3 - 0.3 ) ( kN ) / ( Δ Cell Thickness at 3 kN - Δ Cell Thickness at 0.3 kN ) ) ( mm ) \qquad Eq . ( ii )$$

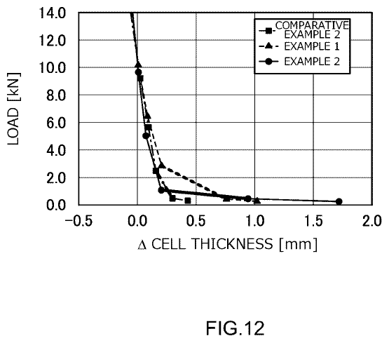

FIG. 12 illustrates a graph that plots cell thickness changes between the first cycle and the fifth cycle under the same load conditions for each of Examples 1 and 2 and Comparative Example 2, where the horizontal axis represents A cell thicknesses (mm) and the vertical axis represents applied loads (kN). On the graph of FIG. 12, the thick lines indicate regions where the load is between 0.3 kN and 3 kN.

### Results

The results in Table 1 suggest that the storage cells according to Examples 1 and 2 whose cell thickness change rates are 0.3% or more (≥0.3) have lower “0.3 to 3 kN spring constants” than the storage cells according to Comparative Examples 1 to 3. This indicates that if a cell thickness reduction occurs due to, for example, a low temperature environment and/or a low SOC condition, the present disclosure would be able to suitably control storage cell thicknesses (i.e., to increase storage cell thicknesses again), so that the degree of loss of a stack restraining load is small. Accordingly, if a stack manufactured by stacking storage cells whose cell thickness change rates are 0.3% or more (≥0.3) suffers a storage cell thickness reduction, the present disclosure would be able to suitably control thicknesses of storage cells, making it possible to reduce a decrease in stack restraining load (i.e., to reduce a restraining load loss).

Although the preferred embodiment of the present disclosure has been described thus far, the foregoing embodiment is only illustrative. The present disclosure may be embodied in various other forms. The present disclosure may be practiced based on the disclosure of this specification and technical common knowledge in the related field. The techniques described in the claims include various changes and modifications made to the embodiment illustrated above. Any or some of technical features of the foregoing embodiment, for example, may be replaced with any or some of technical features of variations. Any or some of the technical features of the variations may be added to the technical features of the foregoing embodiment. Unless described as being essential, the technical feature(s) may be optional.

As described above, specific embodiments of the present disclosure include those described in items below.

### Item 1

A method for manufacturing a stack including rectangular storage cells, the method including:
a preparing step involving preparing the storage cells each including
   a flat wound electrode assembly provided by placing a positive electrode and a negative electrode in layers, with a separator interposed therebetween, and winding the positive electrode, the negative electrode, and the separator,
   a nonaqueous electrolyte, and
   a case containing the wound electrode assembly and the nonaqueous electrolyte; and
a stacking step involving stacking the storage cells in a thickness direction of the storage cells, wherein
when the storage cells prepared in the preparing step undergo five cycles of a process involving applying a load of up to 0.1 MPa to each of the storage cells at a speed of 0.1 mm/min in the thickness direction of each of the storage cells and then reducing the load to 0.01 MPa at a speed of 0.1 mm/min, a relationship between a storage cell thickness X1 determined relative to a contact pressure of 0.04 MPa by a pressurized side F-s curve in a first cycle and a storage cell thickness X5 determined relative to a contact pressure of 0.04 MPa by a pressurized side F-s curve in a fifth cycle satisfies the following expression: (X1−X5)/X1×100≥0.3.

### Item 2

The method according to item 1, wherein
the negative electrode includes a negative electrode substrate and a negative electrode active material layer formed on the negative electrode substrate, and
a length Ln of the negative electrode active material layer in a width direction perpendicular to a longitudinal direction of the wound electrode assembly is 20 cm or more.

### Item 3

The method according to item 2, wherein
when a length of the wound electrode assembly in a direction perpendicular to a winding axis of the wound electrode assembly and perpendicular to a thickness direction of the wound electrode assembly is a height T of the wound electrode assembly, a ratio of the length Ln of the negative electrode active material layer in the width direction to the height T of the wound electrode assembly (Ln/T) is between 2.8 and 3.2.

### Item 4

The method according to any one of items 1 to 3, wherein
the preparing step includes an activating step involving charging each of the storage cells while applying a load to each of the storage cells in the thickness direction thereof, and
the load applied to each of the storage cells in the activating step is between 0.5 MPa and 0.7 MPa.

### Item 5

The method according to any one of items 1 to 4, wherein
the positive electrode is in 30 layers or more.

### Item 6

The method according to any one of items 1 to 5, wherein
the relationship between the storage cell thickness X1 determined relative to a contact pressure of 0.04 MPa by the pressurized side F-s curve in the first cycle and the storage cell thickness X5 determined relative to a contact pressure of 0.04 MPa by the pressurized side F-s curve in the fifth cycle further satisfies the following expression: (X1−X5)/X1×100≤2.0.

What is claimed is:

1. A method for manufacturing a stack including rectangular storage cells, the method comprising:
a preparing step involving preparing the storage cells each including
a flat wound electrode assembly provided by placing a positive electrode and a negative electrode in layers, with a separator interposed therebetween, and winding the positive electrode, the negative electrode, and the separator,
a nonaqueous electrolyte, and
a case containing the wound electrode assembly and the nonaqueous electrolyte; and
a stacking step involving stacking the storage cells in a thickness direction of the storage cells, wherein
when the storage cells prepared in the preparing step undergo five cycles of a process involving applying a load of up to 0.1 MPa to each of the storage cells at a speed of 0.1 mm/min in the thickness direction of each of the storage cells and then reducing the load to 0.01 MPa at a speed of 0.1 mm/min, a relationship between a storage cell thickness X1 determined relative to a contact pressure of 0.04 MPa by a pressurized side F-s curve in a first cycle and a storage cell thickness X5 determined relative to a contact pressure of 0.04 MPa by a pressurized side F-s curve in a fifth cycle satisfies the following expression: (X1−X5)/X1×100≥0.3.

2. The method according to claim 1, wherein
the negative electrode includes a negative electrode substrate and a negative electrode active material layer formed on the negative electrode substrate, and
a length Ln of the negative electrode active material layer in a width direction perpendicular to a longitudinal direction of the wound electrode assembly is 20 cm or more.

3. The method according to claim 2, wherein
when a length of the wound electrode assembly in a direction perpendicular to a winding axis of the wound electrode assembly and perpendicular to a thickness direction of the wound electrode assembly is a height T of the wound electrode assembly, a ratio of the length Ln of the negative electrode active material layer in the width direction to the height T of the wound electrode assembly (Ln/T) is between 2.8 and 3.2.

4. The method according to claim 1, wherein
the preparing step includes an activating step involving charging each of the storage cells while applying a load to each of the storage cells in the thickness direction thereof, and
the load applied to each of the storage cells in the activating step is between 0.5 MPa and 0.7 MPa.

5. The method according to claim 1, wherein
the positive electrode is in 30 layers or more.

6. The method according to claim 1, wherein
the relationship between the storage cell thickness X1 determined relative to a contact pressure of 0.04 MPa by the pressurized side F-s curve in the first cycle and the storage cell thickness X5 determined relative to a contact pressure of 0.04 MPa by the pressurized side F-s curve in the fifth cycle further satisfies the following expression: (X1−X5)/X1×100≤2.0.
